(19) United States
(12) Patent Application Publication
(10) Pub. No.: US 2021/0110729 A1
(43) Pub. Date: Apr. 15, 2021

(54) MACHINE OPERATION TRAINING APPARATUS AND METHOD

(71) Applicant: Linklater's Limited, Kincardine (CA)

(72) Inventors: Larry Fisher, Tiverton (CA); Patrick Gaudreault, Tiverton (CA); Peter Eberl, Kincardine (CA); Rolf Eberl, Kincardine (CA)

(21) Appl. No.: 16/653,600

(22) Filed: Oct. 15, 2019

(51) Int. Cl. G09B 9/00; G09B 5/12; G05B 19/05

(52) U.S. Cl. CPC G09B 9/00; G05B 19/058; G05B 19/054; G09B 5/125

(57) ABSTRACT

Training apparatus and methods are disclosed for teaching practices for operation of machines. The apparatus comprises: a plurality of input selectors; a plurality of status indicators; an alarm; and a programmable controller switchable between programming and operator testing modes. In the programming mode, a sub-set of the control operators is used to select a testing program, and a second sub-set is used to select modifications to the testing program. Each program defines a sequence of input selections and a corresponding sequence of signals from the status indicators. In the testing mode, the controller is configured to receive input selections and to activate the alarm in response to deviation from the sequence of input selections of a selected testing program.

### FIELD

This relates to operator performance training and in particular, to apparatus and methods for training machine operators.

### BACKGROUND

Many industrial facilities have complex control systems designed to improve safety and reliability. However, such control systems typically involve human operators. Therefore, human error is a major contributor to occurrence of industrial incidents. For example, humans are generally prone to errors such as incorrect data or control entry, which can be caused by inadequate checking, misunderstanding of instructions, transposition or misplacement of numbers, and myriad other factors.

Incidents associated with human error can lead to serious consequences including equipment damage, unscheduled outages or lost time, operator injury or death, environmental damage, and impacts on public safety. The potential consequences of such errors can be particularly severe in certain industries, such as power generation, refining, chemical processing and many others.

### SUMMARY

A training apparatus for teaching practices for operation of machines, comprising: a plurality of input selectors; a plurality of status indicators; an alarm; a programmable controller connected with the input selectors, the status indicators and the alarm and switchable between programming and operator testing modes by operation of a mode selector; the controller configured in the programming mode to: responsive to operation of a first sub-set of the input selectors, select an operator testing program of a plurality of operator testing programs each defining a sequence of input selections and a corresponding sequence of signals from the status indicators; and responsive to operation of a second sub-set of the input selectors, modify the sequence of input selections and the corresponding sequence of signals from the status indicators; the controller configured in the operator testing mode to receive input selections and to activate the alarm in response to deviation from the sequence of input selections of a selected testing program.

A method of teaching practices for operation of machines, comprising, at an apparatus comprising a plurality of input selectors and a plurality of status indicators: selecting one of a plurality of operator testing modes by operation of a first subset of the input selectors, the operator testing modes defining a sequence of input selections and a corresponding sequence of signals from the status indicators; selecting an operator testing mode modification by operation of a second sub-set of the input selectors, the modification comprising a modification of the sequence of input selections and a modification of the sequence of signals; activating the selected operator testing mode by operation of a selector of the input selectors; receiving input selections by operation of the input selectors; and activating an alarm in response to a selection that deviates from the sequence of input selections.

A training apparatus for teaching practices for operation of machines, comprising: an enclosure having wheels and a handle for manually moving the apparatus; a plurality of input selectors on the enclosure; a plurality of status indicators on the enclosure; an alarm; a programmable controller within the enclosure, connected with the input selectors, the status indicators and the alarm and switchable between programming and operator testing modes by operation of an input selector; the controller configured in the programming mode to: responsive to operation of a first sub-set of the input selectors, select an operator testing program of a plurality of operator testing programs each defining a sequence of input selections and a corresponding sequence of signals from the status indicators; and responsive to operation of a second sub-set of the input selectors, modify the sequence of input selections and the corresponding sequence of signals from the status indicators; the controller configured in the operator testing mode to receive input selections and to activate the alarm in response to deviation from the sequence of input selections of a selected testing program.

Other aspects of the invention will be apparent.

### BRIEF DESCRIPTION OF DRAWINGS

In the figures, which depict example embodiments:

FIG. 1 is a front view of a machine operator training apparatus;

FIG. 2 is a block diagram of components of the apparatus of FIG. 1;

FIG. 3 is a block diagram of components of a controller of the apparatus of FIG. 1;

FIG. 4 is a diagram of states of the controller of FIG. 3;

FIG. 5 is a diagram of an input-status response sequence defined by an operator testing program at the controller of FIG. 3;

FIG. 6 is a diagram of the sequence of FIG. 5, with modifications representing faults;

FIG. 7 is a schematic diagram of input selectors at the operator training apparatus of FIG. 1, in a configuration for selecting a testing program;

FIG. 8 is a schematic diagram of input selectors at the operator training apparatus of FIG. 1, in a configuration for selecting faults;

FIG. 9 is a schematic diagram of input selectors at the operator training apparatus of FIG. 1, in a configuration for verifying, alignment of the inputs;

FIG. 10 is a flow chart depicting a process of machine operator training; and

FIG. 11 is a perspective view of a machine operator training apparatus in a portable container.

### DETAILED DESCRIPTION

In overview, apparatus and methods are disclosed for error prevention principles applicable to operation of machines. An example disclosed herein provides an interface generally similar to control interfaces that may be present at industrial facilities. For example, the interface includes buttons, dials, switches and feedback output devices that operate in a manner similar to controls that may be encountered in an industrial facility. Example apparatus is further configured to provide feedback in the form of auditory and visual messages, including feedback indicative of successful control selection and failed control selection, such as late or incorrect control selection.

Apparatus and methods disclosed herein may be used to teach practices including task, previews, place keeping, self-checking and communication tools such as use of the phoenetic alphabet and three-way communication.

Apparatus and methods disclosed herein, as well as practices and techniques taught using apparatus and methods herein may be of particular relevance to individuals who control operation of safety-critical machinery, such as plant operators in fields such as power generation, chemical refining, oil and gas production and refining. Moreover, such apparatus and methods disclosed herein, as well as practices and techniques may be of relevance to others, such as supervisors, engineers designing machine control systems, technicians such as repair and shutdown technicians. Apparatus and methods disclosed herein may be relevant to a wide range of machines, in addition to plant controls.

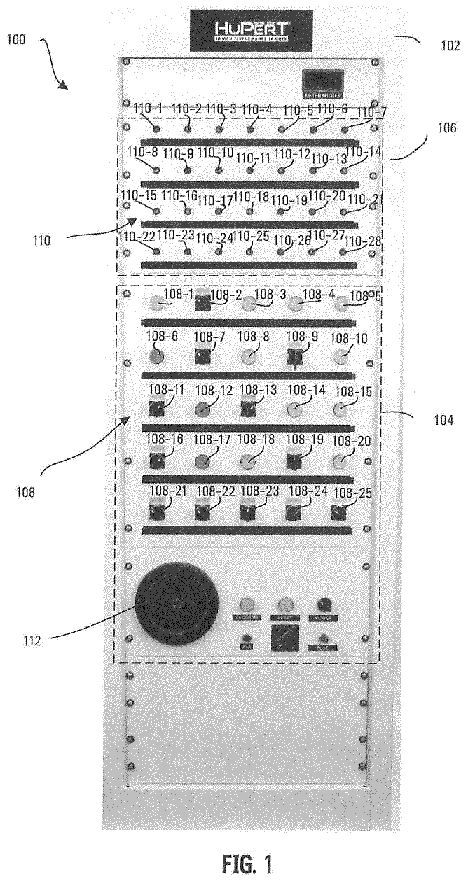

FIG. 1 depicts an example training apparatus 100. Training apparatus 100 has an enclosure 102, which defines an input panel 104 and an output panel 106.

The input panel 104 has a plurality of input selectors 108 and the output panel 106 has a plurality of status indicators 110. Training apparatus 100 further includes an alarm 112.

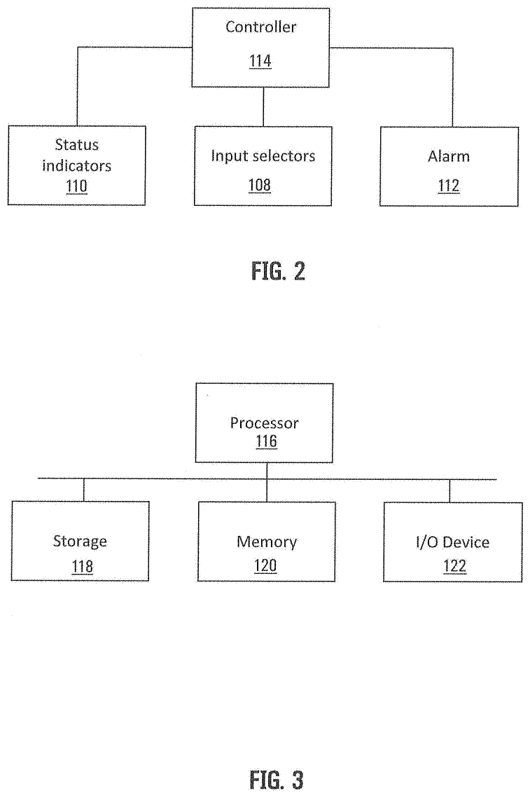

Input selectors 108, status indicators 110 and alarm 112 are interconnected with a controller 114 (FIG. 2). The controller is operable to receive inputs from input selectors 108 and output feedback information by way of status indicators 110 and alarm 112.

In the depicted embodiment, input selectors 108 include a plurality mechanical inputs, such as buttons and switches. Buttons may, for example, be used for a binary input: 1 or 0; ON or OFF. Likewise, some switches may be used for binary inputs. Other input selectors may be used for non-binary inputs. For example, some switches may be used to select between three or more possible settings, or for continuous adjustment within a given range. Buttons and dials may have default positions. For example, buttons and switches may be spring-biased to particular positions.

Additionally or alternatively, input selectors may include non-mechanical inputs. For example, some or all of input panel 104 could be implemented as virtualized controls on a touch-sensitive screen. Other types of inputs are possible, as will be apparent.

In the embodiment of FIG. 1, twenty-five input selectors 108 are present, referred to individually as selectors 108-1, 108-2, . . . 108-25. Thirteen of the selectors are buttons and twelve are switches. However, any number of input selectors could be present, in any combination of buttons, knobs, switches, dials virtualized controls, and other suitable input types.

Each one of input selectors 108 may he assigned an alphanumeric label. The labels may be designed so as to resemble one another visually or when sounded aloud.

As shown, status indicators 110 include an array of twenty-eight bulbs. The bulbs may be one or more colours, e.g. green and red. The bulbs may be individually illuminated and extinguished by controller 114. Although twenty-eight bulbs are shown, any number may be present. Additionally or alternatively, status indicators 110 may include other types of output devices. For example, the status indicators could include one or more display screens, numerical displays, or the like.

Each one of status indicators 110 may be assigned an associated alphanumeric label. The labels may be designed so as to resemble one another visually or when sounded aloud.

Input panel 104 further includes operating mode inputs 111. A first operating mode input 111-1 controls main power to apparatus 100. A second operating mode input 111-2 is operable to reset controller 114. A third operating mode input 111-3 is operable to switch controller 114 between testing program selection, alignment checking, and operator testing modes, as will be described in greater detail.

FIG. 3 depicts functional connections between components of apparatus 100 in greater detail. Specifically, input selectors 108 of input panel 104 are connected to one or more inputs of controller 114. For example, each input selector 108 may be connected to a unique input channel of controller 114. Alternatively, input selectors 108 may be multiplexed on a single input or connected by way of a suitable hub device.

Likewise, status indicators 110 are connected to one or more outputs of controller 114. Each status indicator may be connected to a separate output, or multiple status indicators may be multiplexed or connected by way of a suitable hub device.

Alarm 112 is connected to one or more outputs of controller 114. Optionally, alarm 112 may further be connected to a separate modulator. For example, alarm 112 may be a speaker activated by controller 114, with a separate volume control.

FIG. 3 depicts example components of controller 114. Controller 114 includes a processor 116. Processor 116 may be any suitable processing device such as a specialized microcontroller or general-purpose x86 or ARM processor.

Controller 114 further includes computer-readable storage 118 on which is stored instructions for execution by processor 116 to provide functions as described herein. Controller 114 further includes working memory 120 (e.g. RAM) accessible by processor 116, and at least one input-output device 122 for interfacing with input selectors 108 and status indicators 110.

Controller 114 may be a suitable programmable logic controller (PLC), such as a DirectLOGIC 205 PLC from Koyo Electronics Industries Co., Ltd. of Japan. Controller 114 may be physically connected to input selectors 108 and status indicators 110.

Alternatively, controller 114 may be implemented on a computing device such as a general-purpose PC based on an x86 or ARM processor or system-on-chip. In some embodiments, one or both of input selectors 108 and status indicators 110 may be partially or fully implemented in software, and connections between controller 114, input selectors 108 and status indicators 110 may be connections between software units, such as data passed between applications or portions of a single application.

Instructions at storage 118 define a plurality of operator testing programs, each for delivering a training exercise for a machine operator. As will be described in further detail, the training exercises are designed to demonstrate operational practices protective against occurrence of human error. Each operator testing program defines a sequence of input selections expected to be input by a user with input selectors 108. Each operator testing program further defines a corresponding status output in response to each input selection in the sequence. The instructions in storage 118 further configure controller 114 to trigger alarm 112 in response to a deviation from the expected sequence of input selections.

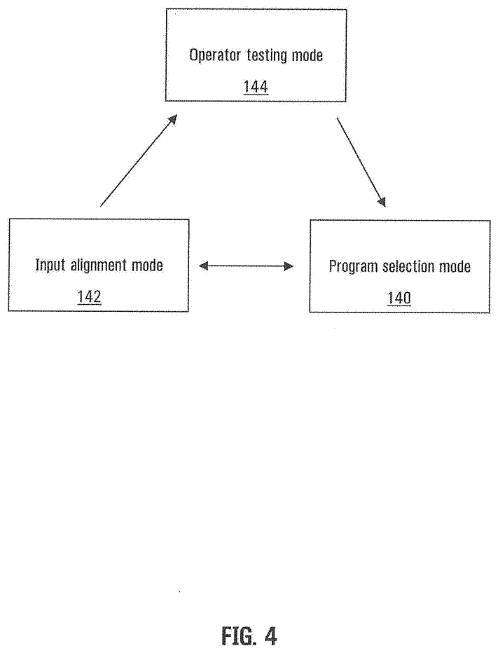

Controller 114 is operable in three modes, as will be described in greater detail. FIG. 4 is a state diagram illustrating the operating modes and transitions between the operating modes. In a first mode 140, which may be referred to as a program selection mode, controller 114 receives inputs identifying one of a plurality of available operator testing programs to be executed. In a second mode 142, referred to as an input alignment mode, controller 114 is configured to ignore inputs from selectors 108, so that the state of each input selector 108 can be checked and manipulated to a correct starting position for a testing program. In a third mode 144, referred to as an operator testing mode, controller 114 operates according to receive inputs from selectors 108 and, if the inputs are received according to a defined sequence, produce a corresponding sequence of responses, or if deviation from the defined sequence is detected, sound an alarm.

Controller 114 is switchable between modes 140, 142, 144 by operation of an operating mode input 111-3. Specifically, actuation of operating mode input 111-3 while in program selection mode 140 causes controller 114 to move to input alignment mode 142. Actuation of operating mode input 111-3 while controller is in input alignment mode 144 causes controller 114 to return to program selection mode 144. In addition, actuation of operating mode input 111-2 while in any mode returns controller 114 to program selection mode 140.

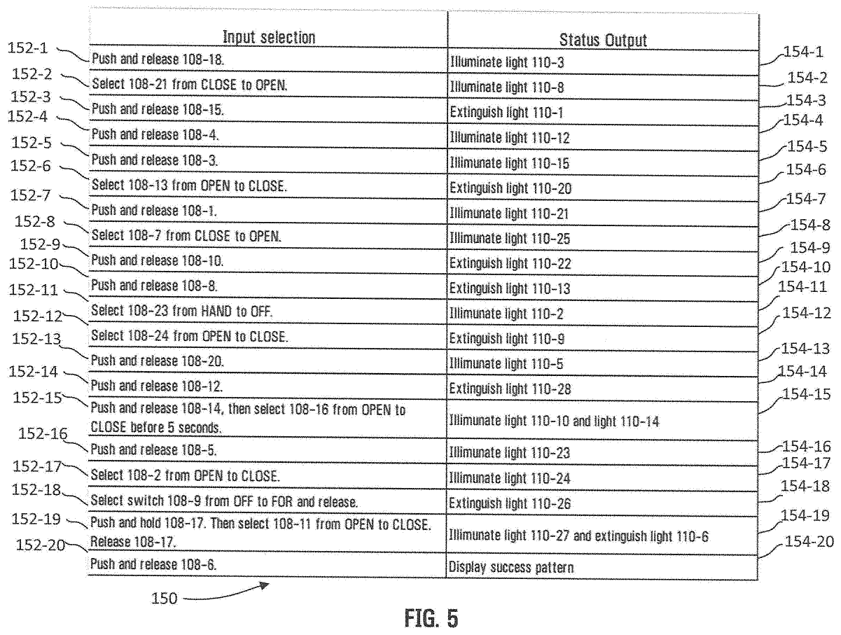

FIG. 5 depicts an operator testing program 150 comprising a sequence of input selections 152 and corresponding status output responses 154. As shown, the sequence of input selections has twenty input selections, referred to individually as selections 152-1, 152-2, . . . 152-20. Corresponding status output responses may be referred to individually as responses 154-1, 154-2, . . . 154-20. However, an operator testing program may include any number of selections and responses.

Selections in an operator testing program can include any type of selection possible using input selectors 108. For example, sequence 152 includes actuation of buttons and setting of dials to specific positions. In addition, some input selections defined in sequence 152 may be timed. For example, selection 152-15 shown in FIG. 4 includes actuation of a button, to be followed by operation of a dial within a defined time, i.e. 5 seconds. Other selections may include simultaneous operation of multiple input selectors 108. For example, selection 152-19 includes simultaneous pressing of a button and turning of a dial.

Responses to selections in sequence 152 can include any type of signal possible with status indicators 110. As depicted, responses 154 include illumination of lights and extinguishing of lights. In addition, responses 154-15 and 154-19 include simultaneous operation of multiple lights, and response 154-20 includes illumination of multiple lights in a defined pattern to signify completion of the testing program.

The sequence of input selections 152 and responses 154 defined by a given operator test pattern may be used for a training exercise in which practices for reducing human error are demonstrated to one or more trainees.

For example, a pair of operator trainees may perform the training exercise using apparatus 100. A first trainee may be given a list of instructions corresponding to the sequence of input selections 152 and status responses 154, and a second trainee may operate apparatus 100.

The first and second trainees may be directed to cooperatively execute the sequence. Specifically, the first trainee may recite each instruction, using a phoenetic alphabet to read alphanumeric labels of input selectors 108. The first trainee may also recite the desired action and the expected status indicator response 154. In the case of selection 152-7, the first trainee may recite “push and release button” and “Response is illuminate light 110-21”. The second trainee, i.e., the operator of apparatus 100 may be directed to repeat the instruction. The first trainee may then confirm the repeated confirmation before the selection is performed. After making the selection, the second trainee may confirm that the expected response is observed.

As will be explained in further detail, if a selection made deviates from the defined sequence of input selections 154, controller 114 activates an alarm. In the depicted embodiment, the alarm is an auditory alarm from speaker 112.

The design of apparatus 100 and of the training exercise defined by operator testing program 150 may cooperate to demonstrate proper communication and verification techniques, and the importance of such techniques. For example, during testing, trainees may trigger the alarm with incorrect selections, or may identify and correct would-be mistakes (“near misses”) by back-and-forth confirmation of instructions. Such occurrences may be more likely if alphanumeric labels assigned to the input selectors and status indicators are selected to be similar to one another, and thus, easily confused.

Operator testing program 150 may also be modified to introduce deviations in the sequence of status output responses 154 produced by apparatus 100. Such deviations may mimic the effect of equipment failures or malfunctions in a real facility.

For example, FIG. 5 depicts an operator testing program 150′, identical to operator testing program 150 except that testing program 150′ includes five (5) faults 156-1, 156-2, 156-3, 156-4, 156-5 (individually and collectively, faults 156). Each fault 156 prevents a status output 154 from occurring in response to the corresponding input selection 152 and requires one or more corrective input selections to be made.

Faults 156 may be selectively activated and any number of faults 156 may be activated simultaneously. That is, while five active faults are shown in operator testing program 150′, other programs may have more or fewer faults.

During operator testing exercises, a trainee operating apparatus 100 may be instructed to recite any unexpected status response or lack thereof to another trainee that is provided with instructions for the exercise. The instructions may identify note the fault and identify corrective input selections, which may be recited to the operating trainee.

As noted, operator testing program 150 is stored in storage 118 of controller 114, for execution by the controller on selection by an operator. A plurality of possible programs 150 may be stored. In one example, six programs are stored, including two short programs. In other examples, more or fewer programs may be stored, subject to limitations of the capacity of storage 118.

Likewise, fault conditions are stored in storage 118 for selective activation. The number of fault conditions that may be stored is limited by capacity of storage 118. Faults may be program-specific. That is, a set of possible faults may be defined for each testing program. Some or all of the individual faults for a given program may be unique to that program. Alternatively or additionally, some generic faults may be defined which may be used to modify any test program.

As will be apparent, the complexity of selecting between programs and faults may increase as the number of stored programs and faults increases. Accordingly, a practical limit may be imposed to limit such complexity.

The testing programs and faults stored in storage 118 may involve input selections from any or all of input selectors 108.

In the depicted example, selection of an operator testing program for execution is done using input selectors 108.

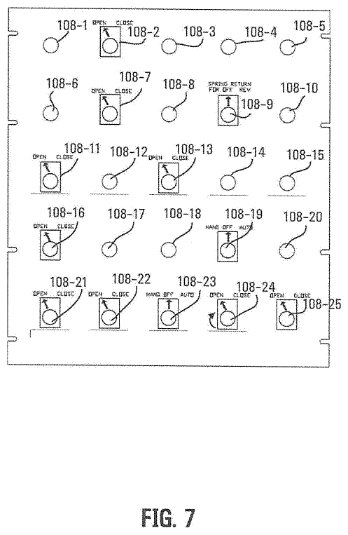

FIG. 7 schematically depicts selection of operator testing program 150 using input panel 104. Prior to selection of a program, controller 114 is placed in program selection mode 140 (FIG. 4). Controller 114 may be placed in the program selection mode 140 by initial power up of apparatus 114, or by actuating mode control input 111-2 to reset the controller. Alternatively, actuation of mode control input 111-3 from the operator testing mode 144 may return controller 114 to the program selection mode 140.

Some or all of input selectors 108 may be set to defined initialization states. Specifically, as depicted, switches 108-2, 108-7, 108-11, 108-13, 108-16, 108-21, 108-22, 108-24 and 108-25 are set to “OPEN” positions. Switches 108-9, 108-19 and 108-23 are set to “OFF” positions.

A subset of input selectors 108 are then actuated to select the desired testing program. In the depicted embodiment, switch 108-24 is moved to a “CLOSE” position. Once input selectors 108 are in the states corresponding to the desired testing program, mode control input 111-3 is pressed, at which point the operator testing program is selected.

Other testing programs may be selected by moving different switches or combinations of switches, or by pressing buttons. For example, another testing program could be selected by moving both of switches 108-24 and 108-25 to “CLOSE” positions.

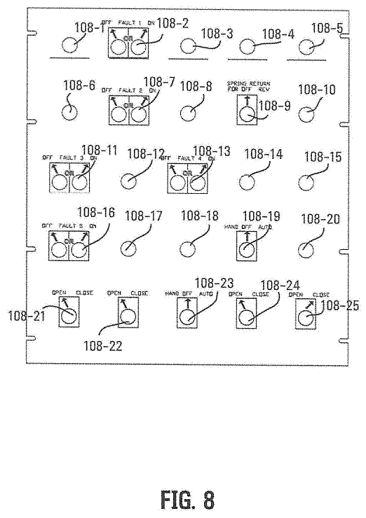

Selection of faults is also done using input selectors 108 while controller 114 is in program selection mode 140. FIG. 8 schematically depicts selection of faults to modify operator testing program 150. As noted above, in the depicted example, five faults 156 are available to be added to testing program 150. The five faults are selected using five switches 108-2, 108-7, 108-11, 108-13 and 108-16. Specifically, fault 156-1 may be activated by moving switch 108-2 to an “ON” position. Fault 156-2 may be activated by moving switch 108-7 to an “ON” position. Fault 156-3 may be activated by moving switch 108-11 to an “ON” position. Fault 156-4 may be activated by moving switch 108-13 to an “ON” position. Fault 156-5 may be activated by moving switch 108-16 to an “ON” position. The same switches may be used to activate faults in other testing programs, although the faults themselves may differ. For example switch 108-2 may activate a fault with a first effect in a first testing program, and a fault with a second effect, e.g. altering illumination of a different light, in a second testing program.

Thus, a base operator testing program and any applicable faults are simultaneously selected based on the states of input selectors 108 when mode control input 111-3 is actuated with controller 114 in the program selection mode 140.

In some embodiments, a first subset of input selectors 108 is reserved for identification of a base operator testing program and a second subset of input selectors 108 is reserved for identification of faults to be activated. The two subsets may collectively include all of the input selectors 108 or only a portion of input selectors 108. For example, in the depicted embodiment, switches 108-2, 108-7, 108-11, 108-13 and 108-16 are reserved for fault activation. Switches 108-9, 108-19, 108-21, 108-22, 108-23, 108-24 and 108-25 are reserved for selection of a testing program. Because different groups of switches are used for activation of faults and selection of a base program, fault selections and program selections do not conflict with one another, such that all available faults can be activated with any base program.

Prior to execution of the selected operator testing program, controller 114 enters an input alignment mode 142 in which the status of each input selector can be verified. Upon transitioning of controller 114 to the input alignment mode 142, controller 114 disables input selectors 108. That is, in the input alignment mode, controller 114 ignores input selectors 108.

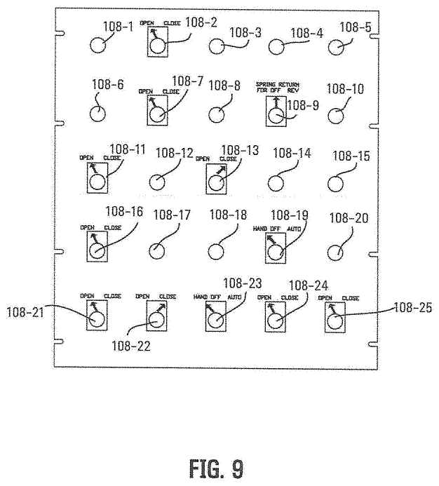

In the input alignment mode, a trainee may be given a diagram schematically illustrating a starting configuration of input selectors 108. An example starting configuration is shown in FIG. 9.

As will be apparent, some of input selectors 108 may need to be manipulated to match the starting configuration. For example, if alignment mode 142 is entered after selecting operator testing mode 150 as depicted in FIG. 7, the state of switch 108-24 will be “CLOSE” and the switch will need to be moved to the state of the starting configuration, i.e. “ON”. The disabling of input selectors 108 prevents controller 114 from responding to manipulation of input selectors. Thus, the input alignment mode effectively provides a period in which controller 114 is idle to inputs from selectors 108 and in which the selectors may be freely manipulated.

Prior to a training exercise, a trainee may be instructed to align all of the selectors 108 to the starting configuration, and to actuate operating mode input 111-3 when complete. Upon such actuation of operating mode input 111-3, controller 114 checks the state of each of input selectors 108. If any of the selectors 108 are in an incorrect state, controller 114 activates alarm 112. If all of the selectors are in the correct state, controller 114 transitions to the operator testing mode 144.

The input alignment mode 142 may provide an opportunity for demonstration of proper equipment checking techniques and the importance of such techniques. Because input selectors 108 are disabled in the input alignment mode 142, an instructor may optionally scramble the states of input selectors 108 after making a selection of a testing program and faults. Accordingly, the difficulty of input alignment may also be customized by the instructor.

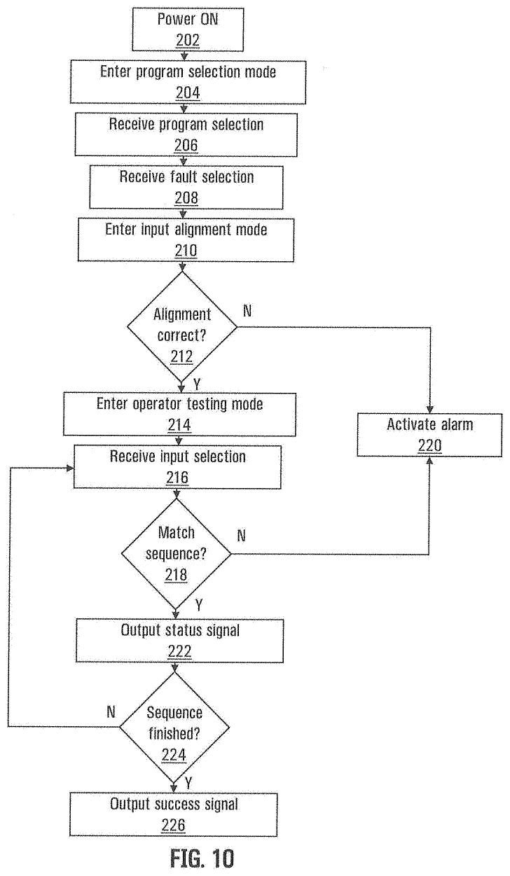

FIG. 10 is a flow chart depicting a process 200 of operation of apparatus 100.

At block 202, apparatus 100 is powered on. After powering on, controller 114 initializes to the program selection mode 140 at block 204.

At block 206, a user, e.g. an instructor, configures inputs 108 to select a desired operator testing program from those available in the storage of controller 114. As noted, configuration of inputs 108 may include manipulation of a first subset of inputs 108. At block 208, the user configures inputs 108 to select any desired faults. Configuration of inputs 108 for fault selection may include manipulation of a second subset of inputs 108, different from the first subset and such that no input 108 is part of both subsets.

The selected base testing program is modified by controller 114 to incorporate any selected faults and at block 210, upon actuation of mode input 111, controller 114 transitions to the input alignment mode 142.

The user, e.g. an instructor, may further manipulate inputs 108 after input alignment mode 142 is initiated, to scramble the states of inputs 108. Another user, e.g., an operator trainee, then checks inputs 108 and moves inputs 108 as necessary to match a starting configuration.

At block 212, mode input 111 is actuated and controller 114 polls the states (e.g. positions) of inputs 108. The state of each input is compared against a defined starting state. If the actual state of each input 108 matches the defined starting state, the process proceeds to block 214, at which controller 114 enters operator testing mode 144. If any of inputs 108 do not match the defined starting state, controller 114 moves to block 220 and activates alarm 112.

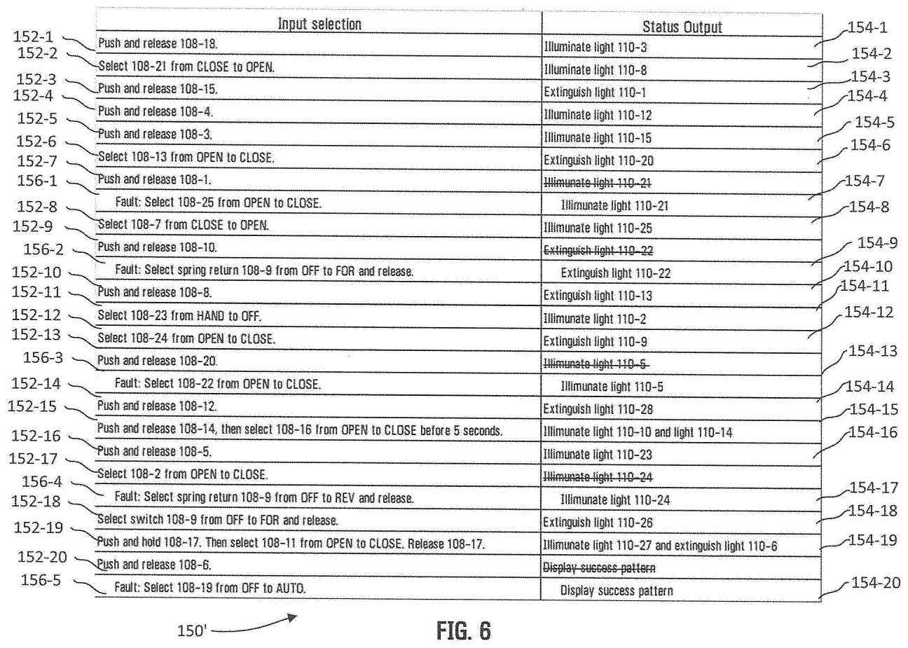

At block 216, a user, e.g. a trainee, makes an input selection as described above with reference to FIGS. 5-6. Controller 114 receives the selection and at block 218 compares the selection to the sequence defined by the current test program.

If the received input does not match the sequence, the process moves to block 220 and controller 114 activates alarm 112. A failure signal may be output, such as by operation of status indicators 110 according to a defined pattern. If the input does match the sequence, the process moves to block 222 and controller 114 outputs a status signal according to the sequence of the current test program by operating one or more of status indicators 110 (FIG. 1). Specifically, in the depicted embodiment, controller 114 outputs a status signal by illuminating or extinguishing one or more lights.

At block 214, controller 114 determines if the sequence of the current testing program is complete. If so, at block 226, controller 114 causes output of a status signal indicative of success. For example, the signal may be illumination of lights in a specific pattern.

Process 200 may manually or automatically repeat after block 220 or block 226. For example, apparatus 100 may automatically return to block 204 and controller 114 may enter program selection mode. Alternatively, apparatus 100 may automatically return to block 210 at which controller 114 enters the input alignment mode, such that the previous testing program is automatically repeated.

Alternatively, an operator may reset apparatus 100 to manually restart process 200 from block 204, or an operator may power off apparatus 100 to manually restart process 201 from block 202.

As described above, input selectors 108 are physical input selectors such as buttons and switches. Alternatively, some or all of input selectors 108 may be implemented in software, e.g. on a touch screen. In such embodiments, selections of testing programs and faults may be made by interaction with software controls. In some embodiments, selections may be made by alphanumeric input, e.g. using a touch screen or attached keyboard.

As depicted in FIG. 1, apparatus 100 is contained in a fixed cabinet for permanent (or indefinite) installation in a facility. In other embodiments, apparatus 100 may be enclosed in a portable container.

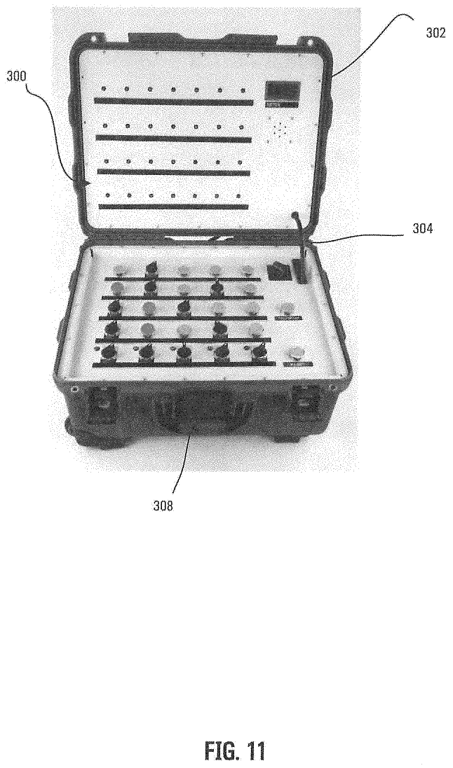

FIG. 11 depicts one such example. As shown in FIG. 11, apparatus 100 is enclosed within a container 300. The container 300 has a rigid plastic or metallic shell 302, and has a hinge 304 for clamshell opening.

As depicted, input panel 104 is carried in one half of shell 302 and output panel 106 is carried in the other half of shell 302. Opening of shell 302 about its hinge exposes both of input panel 104 and output panel 106 for access by a user.

Container 300 is equipped with wheels 306 (not shown) and a handle 308 for manual handling by a person. For example, a user may grasp handle 308 and roll container 300 along wheels 306. Thus, apparatus 100 may be easily portable notwithstanding its relatively large mass.

When introducing elements of the present invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

The term “comprise”, including, any variation thereof, is intended to be open-ended and means “include, but not limited to,” unless otherwise specifically indicated to the contrary.

When a set of possibilities or list of items is given herein with an “or” before the last item, any one of the listed items or any suitable combination of two or more of the listed items may be selected and used.

The above described embodiments are intended to be illustrative only. Modifications are possible, such as modifications of form, arrangement of parts, details and order of operation. The examples detailed herein are not intended to be limiting of the invention. Rather, the invention is defined by the claims.

What is claimed is:

1. A training apparatus for teaching practices for operation of machines, comprising:
a plurality of input selectors;
a plurality of status indicators;
an alarm;
a programmable controller connected with said input selectors, said status indicators and said alarm and switchable between programming and operator testing modes by operation of a mode selector;
said controller configured in said programming mode to:
responsive to operation of a first sub-set of said input selectors, select an operator testing program of a plurality of operator testing programs each defining a sequence of input selections and a corresponding sequence of signals from said status indicators; and
responsive to operation of a second sub-set of said input selectors, modify said sequence of input selections and said corresponding sequence of signals from said status indicators;
said controller configured in said operator testing mode to receive input selections and to activate said alarm in response to deviation from said sequence of input selections of a selected testing program.

2. The apparatus of claim 1, wherein said controller is operable in an input alignment mode in which inputs from said input selectors are disabled.

3. The apparatus of claim 2, wherein said controller is configured to, responsive to operation of said mode selector while in said input alignment mode, compare states of said input selectors to a defined starting state and activate an alarm in response to any deviation from said defined starting state.

4. The apparatus of claim 1, wherein said second sub-set of said input selectors comprises a plurality of input selectors, each for activating a corresponding modification.

5. The apparatus of claim 4, wherein multiple ones of said second sub-set of said input selectors can be simultaneously operated for simultaneously activating multiple modifications.

6. The apparatus of claim 1, wherein said plurality of status indicators comprise a plurality of lights.

7. The apparatus of claim 1, wherein said controller comprises a programmable logic controller (PLC).

8. The apparatus of claim 1, wherein said controller comprises a computer.

9. The apparatus of claim 7, wherein said input selectors are mechanical.

10. The apparatus of claim 9, wherein said input selectors comprise buttons and switches.

11. The apparatus of claim 1, wherein said controller, said input selectors and said status indicators are contained in a portable housing.

12. The apparatus of claim 11, wherein said portable housing comprises wheels and a handle for manual movement.

13. A method of teaching practices for operation of machines, comprising, at an apparatus comprising a plurality of input selectors and a plurality of status indicators:
selecting one of a plurality of operator testing modes by operation of a first sub-set of said input selectors, said operator testing modes defining a sequence of input selections and a corresponding sequence of signals from said status indicators;
selecting an operator testing mode modification by operation of a second sub-set of said input selectors, said modification comprising a modification of said sequence of input selections and a modification of said sequence of signals;
activating said selected operator testing mode by operation of a selector of said input selectors;
receiving input selections by operation of said input selectors; and
activating an alarm in response to a selection that deviates from said sequence of input selections.

14. The method of claim 13, comprising disabling inputs from said in selectors in an input alignment mode of said apparatus.

15. The method of claim 14, comprising comparing states of said input selectors to a defined starting state in response operation of a mode selector while in said input alignment mode, and activating an alarm in response to any deviation from said defined starting state.

16. The method of claim 12, wherein said second sub-set of said input selectors comprises a plurality of input selectors, each for activating a corresponding modification.

17. The method of claim 16, comprising simultaneously activating multiple modifications based on operation of multiple ones of said second sub-set of said input selectors.

18. The method of claim 12, wherein said status indicators comprise a plurality of lights, and said method comprises operating said lights according to said sequence in response to received input selections.

19. The method of claim 12, wherein said apparatus comprises a programmable logic controller (PLC).

20. The method of claim 12, wherein said apparatus comprises a computer.

21. The method of claim 18, wherein operation of a first sub-set of said input selectors comprises actuation of a switch.

22. A training apparatus for teaching practices for operation of machines, comprising:
an enclosure having wheels and a handle for manually moving said apparatus;
a plurality of input selectors on said enclosure;
a plurality of status indicators on said enclosure;
an alarm;
a programmable controller within said enclosure, connected with said input selectors, said status indicators and said alarm and switchable between programming and operator testing modes by operation of an input selector;
said controller configured in said programming mode to:
responsive to operation of a first sub-set of said input selectors, select an operator testing program of a plurality of operator testing programs each defining a sequence of input selections and a corresponding sequence of signals from said status indicators; and
responsive to operation of a second sub-set of said input selectors, modify said sequence of input selections and said corresponding sequence of signals from said status indicators;
said controller configured in said operator testing mode to receive input selections and to activate said alarm in response to deviation from said sequence of input selections of a selected testing program.
